(19) United States
(12) Patent Application Publication
(10) Pub. No.: US 2005/0133065 A1
(43) Pub. Date: Jun. 23, 2005

(54) System and method for automated used oil filter cleaning

(76) Inventors: Kevin E. Kincaid, Tucson, AZ (US); Mark T. Kincaid, Cumberland, RI (US)

Correspondence Address: STEUBING AND MCGUINESS & MANARAS LLP, 125 NAGOG PARK, ACTON, MA, 01720, US

(21) Appl. No.: 10/853,666

(22) Filed: May 25, 2004

Related U.S. Application Data
(60) Provisional application No. 60/531,020, filed on Dec. 18, 2003.

(51) Int. Cl. B08B 3/02

(52) U.S. Cl. 134/22.1; 134/166 R; 134/169 R; 134/170; 134/171; 239/272

(57) ABSTRACT

An automated used oil filter cleaning device for providing the removal of waste oil from used oil filters for subsequent recycling of the waste oil and steel contained in the used oil filters. Spikes are attached to stainless steel blocks, which are connected to pneumatic cylinders. When a used oil filter is in the processing position the spikes penetrate the dome and bottom side of the used oil filter via extension of the pneumatic cylinders. Solvent and compressed air are sent into the used oil filter to assist in removing waste oil from the used oil filter.

### CROSS REFERENCE TO RELATED APPLICATIONS

This application claims priority under 35 USC § 119(e) to provisional application Ser. No. 60/531,020, entitled “SYSTEM AND METHOD FOR AUTOMATED USED OIL FILTER CLEANING”, and filed Dec. 18, 2003.

### FIELD OF THE INVENTION

The disclosed system relates generally to the cleaning of used oil filters, and more specifically to the removal of waste oil from used vehicle oil filters for subsequent recycling of the waste oil and the steel contained in used oil filters.

### BACKGROUND OF THE INVENTION

Over 500 million oil filters are sold each year in the United States, according to estimates from the Filter Manufacturers Council (FMC) for 2002. It is estimated that more than 50 percent of these oil filters are discarded along with the oil they contain. This practice poses a significant threat to surface and ground water from residual used oil and results in a significant loss of natural resources. In the past decade several states have been aggressive in trying to increase the rate of used oil filter recycling.

The State of California has commissioned several studies since 1993 to identify the most significant impediments to used oil filter recycling. In each of these studies the most significant factor identified was the cost of hauling collected used oil filters to a recycling facility. The residual oil contained in used oil filters precludes recycling in the normal scrap metal process. California regulation requires special handling from the point of generation to final disposal. The current processing methods require the centralization of used oil filters resulting in transportation costs that make recycling cost prohibitive. California is representative of a national problem. The small number of facilities handling used oil filters discourages state and local governments from addressing this problem.

A unique solution should allow for the introduction of used oil filters into the local scrap metal process. This can be best accomplished at the point of generation. A cost effective method that can separate the oil from the steel filter housing at the point of generation would facilitate the recycling of both waste streams locally, through readily available and well established procedures. This solution must meet the most stringent Federal, State and Local regulatory requirements and meet the needs of the automobile service industry with respect to cost and safety. The disclosed system described here exceeds all these criteria.

An oil filter, as the name implies, is a device for removing particulate matter from a circulating lubrication oil to preclude the particulate matter from eroding the mechanical surfaces being lubricated by the oil. An oil filter is particularly important, for example, in the internal combustion engine of an automobile since the travel of an automobile exposes the bearing surfaces of the engine to numerous sources of potentially damaging particulate matter. The purpose of the oil filter, therefore, is to remove and trap all particulate matter above a certain microscopic size range. It is recommended that the oil filter for each automobile be replaced every 3,000 to 6,000 miles of travel, depending upon the particular driving conditions for that automobile.

Customarily, the used oil filter is replaced with a new oil filter and the used oil is drained and replaced with fresh oil. The used oil filter is drained of a substantial portion of the residual oil and then discarded or sent to a recycling facility. However, the disposal of used oil filters represents a significant waste disposal problem since even a small amount of residual oil will contaminate the soil and ground water in a landfill. In addition, many bearing surfaces are fabricated from a Babbitt metal, which includes tin, antimony, and copper so that the natural wear of these surfaces will release these metals and others such as chrome into the lubricating oil.

The Filter Manufacturing Council (FMC) estimates that approximately 500 million oil filters are sold each year in the United States. Of these 500 million filters, the FMC estimates that more than 50% are disposed in solid waste landfills. The State of California Integrated Waste Management Board completed a study that determined that there are 1,700 pounds of recyclable steel and 60-70 gallons of recyclable oil in one ton of used oil filters. In view of the foregoing, it would be advancement in the art to provide a process for cleaning used oil filters. A further advancement to the art would be to provide a process that could separate the recyclable steel and recyclable oil at the point of generation.

The handling and disposal of used oil filters are directly affected by federal and state regulation. Handling and disposal of used oil filters is regulated in all fifty states. At a minimum, states must meet requirements in the federal regulations contained in 40 (Code of Federal Regulations) CFR. Many state regulations go beyond federal requirements. In several states used oil filters are regulated as a hazardous waste:
40 CFR 261.4(b)(13)
Non terne-plated used oil filters that are not mixed with wastes listed in Subpart D of this part are:
   Solid Waste
      (40 CFR 261.3 through 261.35) if these oil filters have been gravity hot-drained by one of the following methods:
      (i) Puncturing the filter anti-drain back valve or the filter dome end and hot-draining;
      (ii) Hot-draining and crushing;
      (iii) Dismantling and hot-draining, or;
      (iv) Any other equivalent hot-draining method that will remove used oil. Hot draining is defined as draining the oil filter at near engine operating temperature and above 60 degrees Fahrenheit. All states recommend recycling filters rather than land filling when possible.

In order to meet the minimum federal requirements, businesses must follow a multi-step process that can be both time consuming and expensive. After removing the filter from the vehicle, operators must hot drain the filter in accordance with methods listed in 40 CFR. The least expensive method involves puncturing the dome of the filter and placing it over a container to drain. Most states require 12 hours to complete this process. Typically this is accomplished by draining the filter on a screen covering a 55-gallon drum. Used oil drains through the screen and eventually is added to the used oil waste stream.

Another method found in many facilities involves the use of a hydraulic crusher. After hot draining, the filter is placed in the crusher. Crusher capacity can vary depending on size and expense. In all cases, the filters are introduced and removed manually. After, the filter is reduced to approximately 1/4 Of its original size. Crushers are typically found in facilities that are required by state or local regulation to ship filters to a recycling facility. Operators use crushers to reduce the volume of the filters, which reduces the cost of shipping the filters off site. Even after crushing, a used oil filter will retain 5% to 10% of used oil based on estimates advertised by crusher manufacturers.

The 5% to 10% figure is significant. This amount of oil retained in the filter eliminates the possibility that the filter can be recycled at the local level. Scrap metal recyclers are reluctant to accept crushed oil filters because they will continue to leak oil in an amount that may expose the metal recycler to various federal, state, and local environmental regulations. The oil retained in the filter, even after the filter is crushed, precludes filters from being handled seamlessly in the normal scrap metal process. The amount of scrap metal involved does not make this a viable business option and most local scrap metal operators refuse to take them.

There are facilities that are specifically designed to process used oil filters. These facilities use various methods to reclaim the steel in filters. In most cases the oil retained in the filter is burned off in the process and acts as a fuel substitute. There are relatively few of these facilities across the country. This fact negatively affects efforts to recycle filters. The California Integrated Waste Management Board published a paper in 1998 titled Residential Used Oil Filter Collection Pilot Program Report.

The key findings and conclusions from the pilot are as follows:
There are few convenient opportunities for the public to recycle filters.
There is a lack of public knowledge of the environmental impact of the illegal disposal of used oil filters.
The principal barrier to establishing and maintaining collection opportunities is the cost of hauling.
Local governments lack the resources necessary to meet this challenge and businesses and industry are reluctant to support collection because of the significant cost.

Previous approaches have required the centralization of oil filters, often shipping them across state lines. The cost of hauling to a centralized facility discourages efforts to recycle filters. An improved solution should meet one or all of the following criteria:
A separation of the oil and the steel filter casing at the facility where it is generated.
A method that meets all Federal, State and Local requirements and regulations.
A method that allows the steel and oil to be recycled at the local level.
A method that addresses the needs of the operator.
A method that addresses the needs of the local metal recycling market.

Many previous systems failed commercially because they did not meet at least one of the criteria cited. Schlise (1997), U.S. Pat. No. 5,667,699, DeBano Jr. (1997), U.S. Pat. No. 5,598,951, Ross et al. (1993), U.S. Pat. No. 5,297,332 and Crosslen et al. (1993), U.S. Pat. No. 5,205,195 are examples of devices that did not meet the needs of the operator and did not meet the needs of the local metal recycler. All require an increase in time the operator has to spend handling the oil filter. None of these devices removes the amount of oil necessary to meet the needs of the local metal recycler. In all three examples, further processing would be necessary to eliminate residual oil from the inside and outside of the filter.

Guymon (1994), U.S. Pat. No. 5,298,079, Ter Har (1994), U.S. Pat. No. 5,274,906, Ross et al. (1994) U.S. Pat. No. 5,297,332 and Folmar (1990), U.S. Pat. No. 4,967,776, are semi automatic devices that increase the handling time of the operator. Guymon and Folmar provide devices that have a footprint too large to fit in the average oil change facility. Slack et al. (1994), U.S. Pat. No. 5,299,348 employs a pneumatic ram and a microprocessor, using the ram for positioning the filter only.

Brittain et al. (1994), U.S. Pat. No. 5,321,877, is a manual device that requires extra handling and requires further processing to remove residual oil. Hua (1993), U.S. Pat. No. 5,249,608 employs pressurized air in a semi automatic multi-step process requiring extra handling. Tasch et al. (1993), U.S. Pat. No. 5,243,754 provides a device to separate the components of the used oil filter but does not address the residual oil issue sufficiently to meet the needs of the local metal recycling market.

In patent application 2003/0101564 A1 Rice et al. provide a method to sever the base plate while simultaneously crushing the body of the filter. This method relies heavily on the temperature of the filter to remove oil. The amount of residual oil increases as the temperature of the oil and filter decreases. This problem is not addressed by the device and could lead to inconsistent results. This would preclude the handling of the processed filters by the local metal recycling market. Bedi (2002), application number 2002/0069693 A1 provides a method utilizing pressurized air, forcing the air through the engine while the filter is still attached. This method will likely require further processing once the filter is removed from the engine before it can be managed by the local metal recycling market.

Frederick (1996) U.S. Pat. No. 5,484,382 uses a centrifuge to spin the oil out of the oil filters. The operator manually punctures the dome of the filter and then places it in the apparatus. This process removes up to 95% of the oil, which will still prevent the filters from being introduced seamlessly into the scrap metal recycling process.

### SUMMARY OF THE INVENTION

This disclosed system provides for the removal of oil from a used oil filter in a manner that maximizes the recycling potential of the oil and the steel contained in the filter. The disclosed system is made up of a frame composed of support tracks, primary and secondary, which provides for holding pneumatic cylinders on each track. These tracks intersect each other, for example with the primary track at 90 degrees from secondary. The point at which the tracks meet is where a used oil filter is placed to be processed. Attached to each pneumatic cylinder is a processing block, primary and secondary. Embedded into the primary processing block is a solid and hollow carbide spike, and the secondary processing block has a solid carbide spike, all three are pointed. The pneumatic cylinders utilizing compressed air extend the processing blocks so that the carbide spikes can penetrate the used oil filter.

A solid spike connected to the primary processing block is positioned to penetrate the dome of the used oil filter in a region of the dome over an internal dome cap, which seals the top of the internal center tube of the filter, and disrupts the filter structure. Under normal operating conditions, an oil filter is designed to trap contaminants in dirty oil from a vehicles engine and then allow clean oil to return to the engine. By disrupting the used oil filter's internal structure, the disclosed system can effectively remove used oil from the filter during the cleaning process by allowing used oil to flow past the internal dome cap that normally seals used oil from flowing down the internal center tube.

A hollow spike connected to the primary processing block is positioned to penetrate a region of the dome of the used oil filter over the filter media, or between the filter media and a sidewall of the filter, and provide a path for solvent and compressed air to be passed into the used oil filter for cleaning.

A solid spike connected to the secondary processing block penetrates the bottom sidewall of the used oil filter just above the bottom of the used oil filter to provide for additional drainage of fluids during the processing cycle.

During a processing cycle the primary pneumatic cylinder is extended allowing for the spikes attached to the primary processing block to penetrate the dome of the used oil filter. Once the contents of the used oil filter have been disrupted, solvent is pumped through the hollow spike. Solvent fills the used oil filter and displaces the oil. Both solvent and oil flow out of the used oil filter via the disruption in the oil filter's internal structure caused by the solid primary block spike.

The processing cycle continues to alternate between pumping solvent and compressed air through the hollow spike and into the used oil filter. During the cycle the secondary processing block is extended and retracted to puncture a hole into the used oil filter for additional drainage of oil and solvent. When the processing cycle is complete the used oil filter exits the disclosed system so it may be recycled.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1-A is a perspective front right side view of the frame constructed in accordance with an embodiment of the disclosed system, showing a frame without components.

FIG. 1-B is a perspective back left side view of the frame of FIG. 1-A.

FIG. 2 is a perspective front right side view of the primary block with two spikes connected, which is used during processing to puncture two holes into the dome of the used oil filter as well as deliver air and solvent to remove the used oil from the used oil filter.

FIG. 3 is a perspective front right side view of the secondary block with one spike connected, which is used during processing to puncture one hole into the bottom side of the used oil filter for draining used oil and solvent from the used oil filter.

FIG. 4 is a perspective front right side view of the primary pneumatic cylinder with primary block attached. The primary pneumatic cylinder extends the primary block, with spikes, to puncture the dome of a used oil filter during processing.

FIG. 5 is a perspective back left side view of the secondary pneumatic cylinder with secondary block attached. The secondary pneumatic cylinder extends the secondary block, with spike, to puncture one hole into the bottom side of the used oil filter.

FIG. 6-A is a perspective front right side view of the frame of FIG. 1-A with the components connected to the frame found in FIG. 4 and FIG. 5.

FIG. 6-B is a perspective back left side view of the frame of FIG. 6-A with the components connected to the frame.

FIG. 7-A is a perspective view of the two processing blocks with attached spikes and their positions relative to a used oil filter during processing. This view also shows the secondary spike hole made by the secondary spike.

FIG. 7-B is a perspective view of the two processing blocks with attached spikes and their positions relative to a used oil filter during processing. This view also shows the primary spike holes made by the primary block spike and the primary block air/solvent spike.

FIG. 8 is a perspective horizontal cross-section view of the two processing blocks with attached spikes and their positions during insertion into the used oil filter.

FIG. 9 is a perspective view of two oil filters superimposed upon one another, one small diameter oil filter superimposed on a large diameter oil filter, with a view from the top of the dome of an oil filter, which illustrates the penetration points of the primary block spikes.

FIG. 10-A and 10-B is a flow chart of the processing cycle managed by the program logic controller.

### DETAILED DESCRIPTION OF EXEMPLARY EMBODIMENTS

This application claims priority under 35 USC § 119(e) to provisional application Ser. No. 60/531,020, entitled “SYSTEM AND METHOD FOR AUTOMATED USED OIL FILTER CLEANING”, and filed Dec. 18, 2003, all disclosures of which are hereby included by reference herein.

In the following description, certain specific values of physical attributes, such as dimensions, sizes, respective angles, etc., are given with respect to the illustrative embodiment shown in the Figures. Such specific values are provided only for purposes of explanation with regard to the illustrative embodiment, and accordingly the present invention is not limited in its application to embodiments using these specific values. Those skilled in the art will accordingly recognize that the present invention may be embodied using a variety of specific dimensions, sizes, component angles, etc., as appropriate for a given implementation or operational environment.

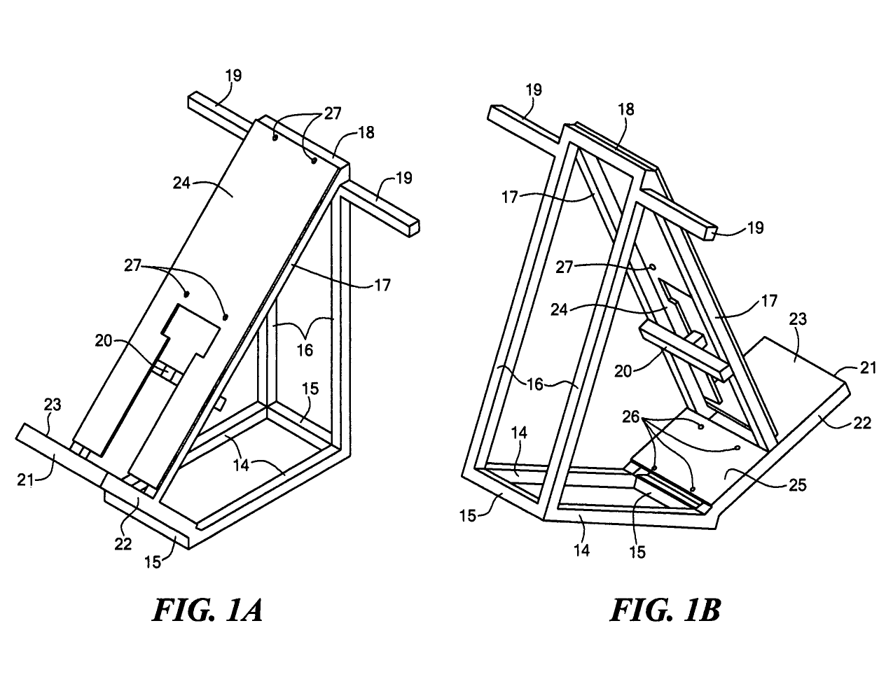

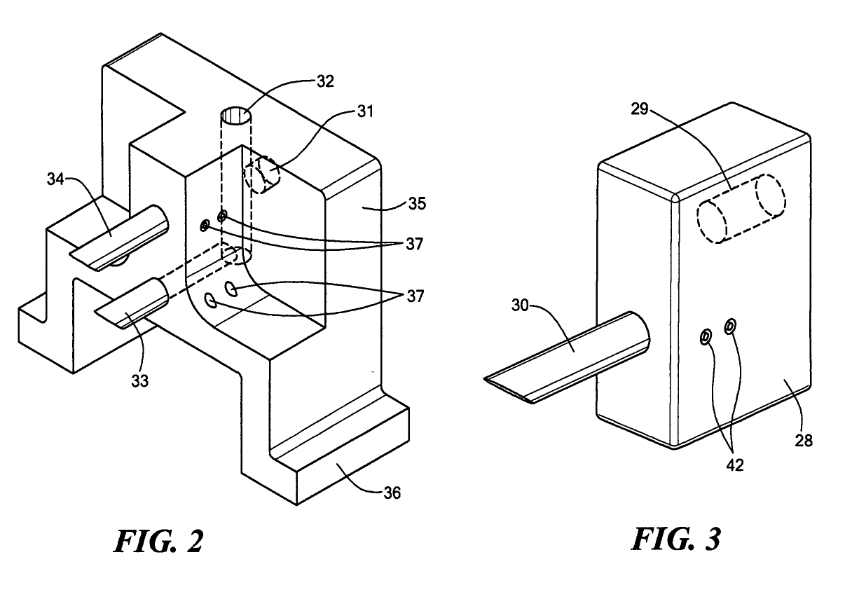

FIG. 1-A is a perspective view taken from the front right side of the frame without the components attached. Frame base supports 14, quantity two, are made of 2.54 cm square steel tubing at 0.3175 cm thickness with a length of 41.91 cm. This steel tubing configuration is used for all base, vertical, and connector components (FIG. 1-A numbers 14-22). Frame base connectors 15, quantity two, are welded to the inside side surfaces of the frame base supports 14 to form a rectangular configuration with a length of 17.78 cm. Frame vertical supports 16, quantity two, are welded at the back and on-top of each corner surface of the frame base supports 14 to form an inside 90 degree angle and have a length of 66.04 cm. Frame horizontal connector 18, quantity one, is welded between the inside side surfaces and at the top of the frame vertical supports 16 with a length of 17.78 cm. Frame component support extensions 19, quantity 2, are welded 2.54 cm down from the top of the frame vertical supports 16 on the outside surfaces at 90 degrees to the frame vertical supports 16 and have a length of 18.415 cm. Primary track supports, quantity two, 17 are welded to the top corners of the frame vertical supports 16 forming an inside 45 degree angle between the primary track supports 17 and the frame vertical supports 16 and have a length of 71.12 cm. Secondary track supports 22, quantity 2, are welded at a 135 degree angle at each top surface front corner of the frame base supports 14 and have a length of 38.1 cm. Secondary track supports 22 are welded again to each bottom end of the primary track supports 17 forming an inside 90 degree angle. Secondary track connector 21 is welded between the top inside side surfaces of the secondary track supports 22 with a length of 17.78 cm. Oil filter support plate 23 is 0.635 cm thick plate steel, is welded to the top surface of the secondary track supports 22 secondary track connector 21, and meets the top surface of the primary track supports 17 with a width of 22.86 cm and a height of 16.51 cm. All plates are steel and 0.635 cm thick. Secondary track pneumatic cylinder anchor plate 25, FIG. 1-B, is welded to the secondary track supports 22 and meets the bottom surface of the primary track supports 17 with a width of 22.86 cm and a height of 19.05 cm. Secondary track pneumatic cylinder anchor holes 26, FIG. 1-B will vary in location and diameter depending upon pneumatic cylinder manufactures specifications but each hole will be equal distance from the secondary track pneumatic cylinder anchor plate 25 side edges. A gap of 2.54 cm in width is created between the oil filter support plate 23 and the secondary track pneumatic cylinder anchor plate 25, FIG. 1-B. This gap width is the equivalent of the width of the steel tubing. The primary track pneumatic cylinder anchor plate with primary block slot 24 is welded to the top surface of the primary track supports 17 with a 2.54 cm space between the end of the primary track pneumatic cylinder anchor plate 24 and the top surface of the oil filter support plate 23 width is 22.86 cm and height is 68.58 cm. Primary block slot 24 is defined by two sections. The top section is space for the primary block 35, FIG. 2, when it is in the retracted position. This space also allows for installation and removal of the primary block 35 when connected to the primary track pneumatic cylinder (PTPC) 41, FIG. 4. The top section space is 10.795 cm in width and 5.715 cm in height. The bottom section of the primary block slot 24 is 7.9375 cm in width, on center of the primary track pneumatic cylinder anchor plate 24 while the height can vary depending on the range in length of the used oil filters to be processed. This is also true of the primary track pneumatic cylinder 41, FIG. 4, and corresponding pneumatic cylinder anchor holes 27. The pneumatic cylinder 41, FIG. 4, length will be dependent on the range in length of used oil filters to be processed and will dictate where the pneumatic cylinder anchor holes 27 are placed as well as the diameter of these holes which is defined by the manufacture of the specific pneumatic cylinder. Primary track horizontal connector with stub 20 is 2.54 cm square steel tubing with a length of 22.86 cm, is welded to the bottom surfaces of the primary track supports 17 below the top section of the primary block slot 24 and its location is dependent on the range in size of used oil filters to be processed. The stub is made of 2.54 cm square steel tubing, is 3.175 cm in height, and is welded to the center point of the primary track horizontal connector 20.

FIG. 1-B is a perspective view taken from the back left side of FIG. 1-A.

FIG. 2 is a perspective view taken from the front right side of the primary block 35. The primary block 35 is made of stainless steel and has gross dimensions of 10.16 cm in length, 4.1275 cm in depth, and 10.16 cm in height. The bottom of the primary block 35 is slotted at 5.08 cm in length, 4.1275 cm in depth, and 3.96875 cm in height, on center. The front face of the primary block 35, on each side of center, is recessed to a depth of 1.74625 cm with a length starting at each side edge of the front block face of 3.81 cm, and a height measured from the top front of the block down at 3.96875 cm. The front face of the primary process block 35, on center, is 2.54 cm in width and 6.19125 cm in height. Two spike holes, on center, are 0.9525 cm in diameter with a depth of 1.27 cm. The bottom spike hole where the primary block air/solvent spike 33 is inserted is 0.79375 cm, on center, from the bottom edge of the center slot to the center point of the hole. The top spike hole where the primary block spike 34 is inserted is 3.96875 cm, on center, from the bottom edge of the center slot to the center point of the hole. Primary block setscrews and set screw holes 37 two per spike, are used for retaining primary block spikes 33, 34, are on center and parallel with each spike and each setscrew hole is 0.238125 cm in diameter. Primary block spikes 33, 34, are made of carbide and are 0.9525 cm in diameter. The back-end of the primary block spikes 33, 34, is flat and the fronts of the spikes are cut at a 45 degree angle. Each spike has a flat, setscrews press against the flat to anchor spike in hole, starting from the back of the spike and are 1.27 cm in length and 0.15875 cm in depth. Primary block air/solvent spike 33 is 3.81 cm in length, is hollow, on center, for the length of the spike with an inside diameter of 0.44958 cm. Primary block spike 34 is 5.3975 cm in length and is solid. Primary block air/solvent channel 32 is divided into two parts, vertical and horizontal channel. The vertical channel is 0.9525 cm in diameter and is 2.06375 cm, on center from the front face of the primary block 35 to the center of the vertical channel. The vertical channel is 5.87375 cm in depth measured from the top of the primary block 35. The vertical channel is threaded as well, standard pipe thread, to a depth of 1.27 cm from the top of the primary block 35. The horizontal channel is connected to the vertical channel with the primary block air/solvent spike 33 hole. The connection is 0.44958 cm, equivalent to the inside diameter of the primary block air/solvent spike 33, in diameter and 0.3175 cm thick, on center, with the primary block air/solvent spike 33 hole. Primary block attachment hole 31 is located on the back face of the primary block 35 on center, 3.175 cm from the bottom slot, 1.27 cm in diameter, and is 1.27 cm deep. The primary block attachment hole is threaded and provides for attachment to the primary block spacer 39, FIG. 4. Primary block retaining feet 36 are 2.54 cm width, 4.1275 cm in depth, and 1.27 cm in height. During extension of the primary track pneumatic cylinder 41 these feet glide underneath the primary process block slot, bottom section 24 with a 0.15875 cm gap between the bottom surface of 24 and the top surface of 36.

An alternative embodiment of the horizontal and vertical channels inside the primary block 35 is to eliminate the vertical channel and have the horizontal channel exit the back of the primary block 35. Connecting of the hose that delivers solvent and compressed air would be the same as the connection of the preferred embodiment.

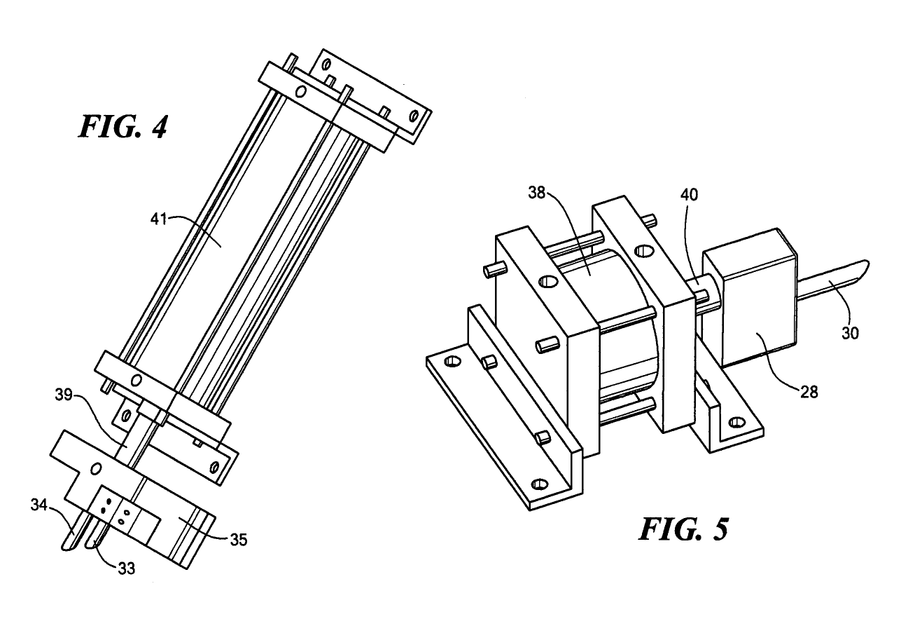

FIG. 3 is a perspective view taken from the front right side of the secondary block 28. Secondary block 28 is 2.54 cm wide, 4.1275 cm deep and 6.35 cm high. Secondary block spike 30 made of carbide, is 0.9525 cm in diameter, 5.08 cm in length, flatted at back end, cut to a 45 degree angle on the front end, solid. Secondary block spike 30 has a flat that extends in length from the back of the spike 1.27 cm and is 0.15875 cm in depth. Secondary block spike 30 hole, where the secondary block spike 30 is inserted is 0.9525 cm in diameter, 1.27 cm in depth, and is 1.11125 cm, on center, from the bottom front edge of the secondary block 28 to the center of the secondary block spike 30 hole. Two secondary setscrew holes 42 run parallel with the secondary block spike 30 hole and are 0.238125 cm in diameter. Secondary setscrews 42 are inserted to anchor secondary block spike 30. Secondary block attachment hole 29 is threaded and provides for attachment to the secondary block spacer 40, FIG. 5. Secondary block attachment hole 29 is 1.27 cm in diameter, 1.27 cm in depth, and is 5.55625 cm high from the bottom back edge of the secondary block 28 on center to the center of the secondary block attachment hole 29.

FIG. 4 is a perspective view taken from the front right side of the primary track pneumatic cylinder 41 with the primary block 35 and block spikes 33, 34, attached. The primary track pneumatic cylinder 41 is provided for illustrative purposes and represents a single possible pneumatic cylinder configuration that could be implemented consistent with principles of the invention. Primary block spacer 39 is 3.175 cm in length and 1.905 cm in diameter. The front of the primary block spacer 39 is a male threaded stub 1.27 cm in diameter and 1.27 cm in length. The male threaded stub is attached to the primary block attachment hole 31, FIG. 2. The back end of the primary block spacer 39 is a female threaded hole 1.27 cm in diameter and 1.27 cm in length. The female threaded hole is used to attach to the pneumatic cylinder rod, which is contained within the pneumatic cylinder that extends and retracts during processing.

FIG. 5 is a perspective view taken from the back left side of the secondary track pneumatic cylinder (STPC) 38 with the secondary block 28 and block spike 30 attached. The secondary track pneumatic cylinder 38 is provided for illustrative purposes and represents a single possible pneumatic cylinder configuration that could be implemented. The secondary track pneumatic cylinder 38 uses a fixed pneumatic stroke length of 1.905 cm. The stroke length represents the distance of travel of the pneumatic cylinder rod and as a result the distance of travel of the secondary block 28. Secondary block spacer 40 is the same configuration as the primary block spacer 39, FIG. 4.

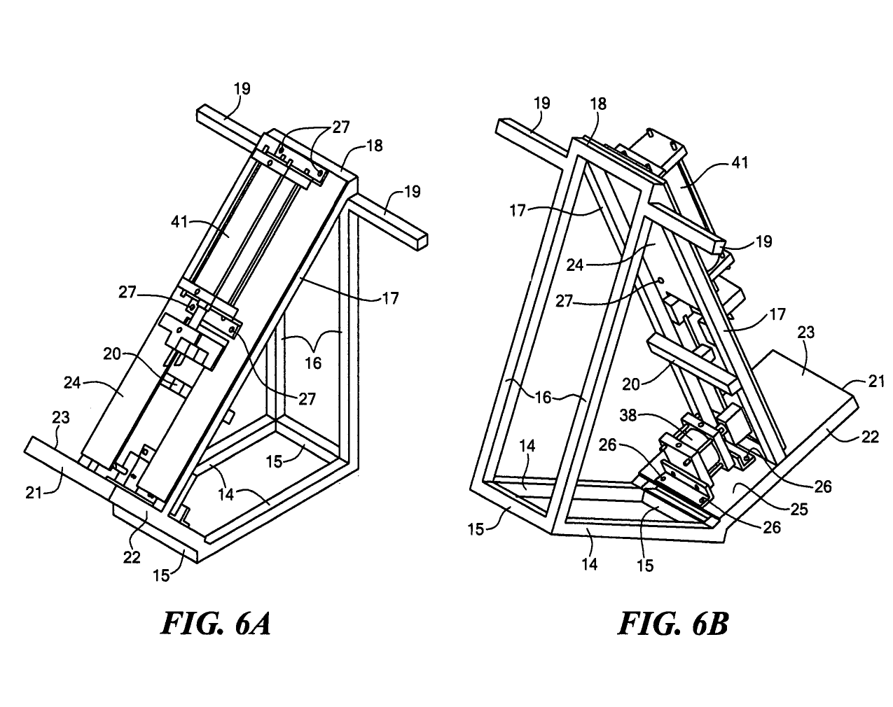

FIG. 6-A is a perspective view taken from the front right side of the frame with components attached.

FIG. 6-B is a perspective view taken from the back left side of FIG. 6-A.

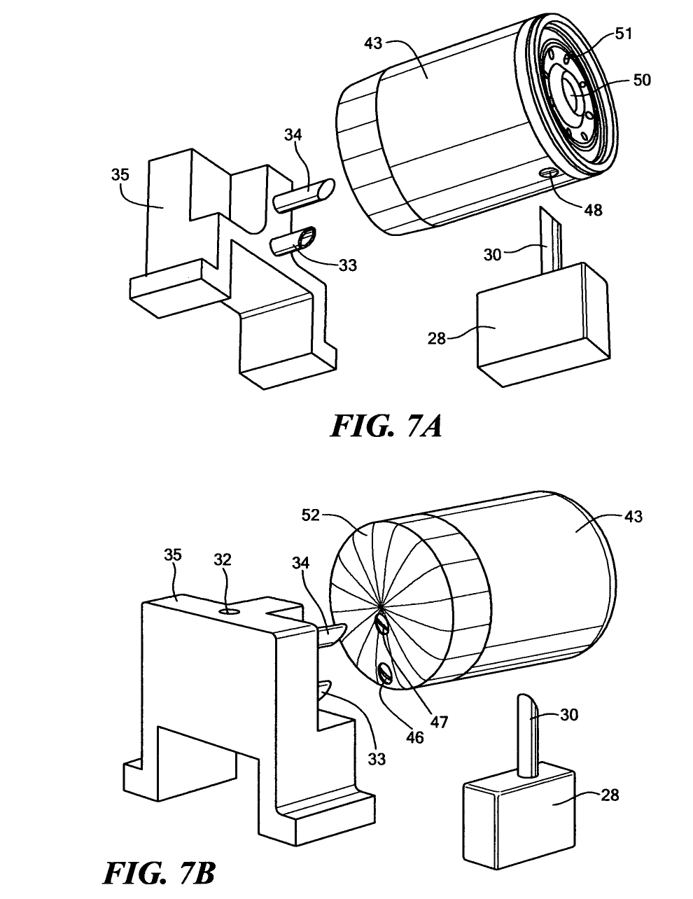

FIG. 7-A is a perspective view of the two processing blocks 28, 35, with attached spikes 30, 33, 34, and their positions relative to a used oil filter 43 during processing. The used oil filter secondary spike hole 48 is shown and is representative in appearance of when the secondary block 28 is retracted from the used oil filter 43 during processing.

FIG. 7-B is a perspective view of the two processing blocks 28, 35, with attached spikes 30, 33, 34, and their positions relative to used oil filter 43 during processing. The used oil filter primary spike hole 47 and the primary air/solvent spike hole 46 is shown and is representative in appearance of when the primary block 35 is retracted from the used oil filter 43 during processing.

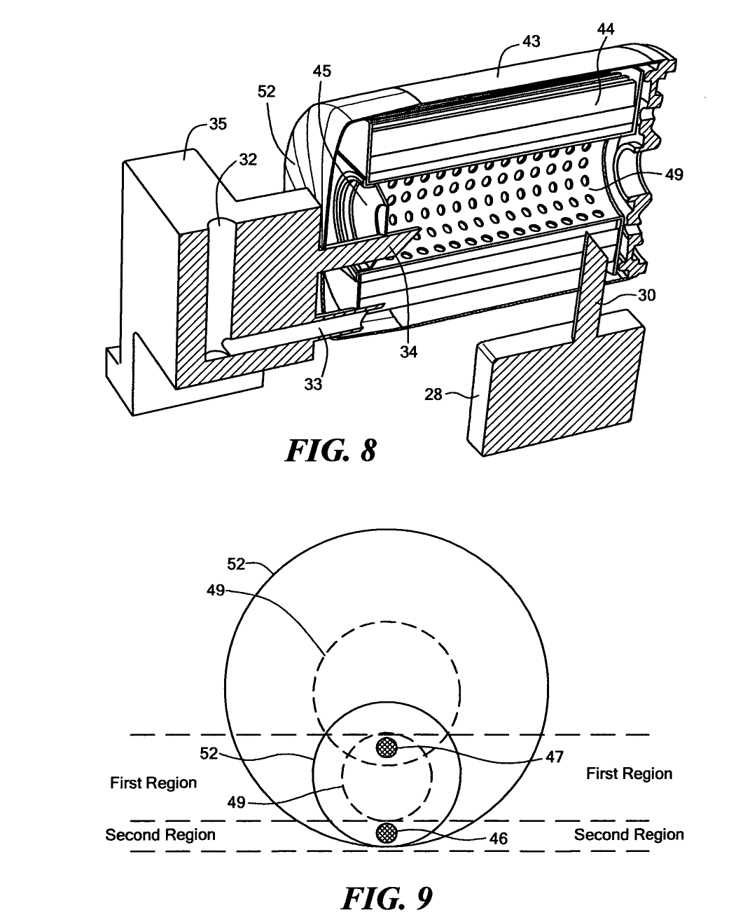

FIG. 8 is a perspective horizontal cross-section view of a used oil filter and of the two processing blocks 28, 35, with attached spikes 30, 33, 34, and their positions during extension of the primary and secondary blocks into the used oil filter. Shown is the primary block air/solvent channel 32 and the primary air/solvent spike 33 connected to the channel and the location of the spike in the used oil filter during extension of the primary block during processing. Secondary block spike 30 is also shown penetrating the used oil filter during extension of the secondary block during processing.

FIG. 9 is a perspective top view of the dome of two used oil filters superimposed laying on a common side or the resting position of the used oil filter at the processing position of the disclosed system. This view represents the range in diameter, smallest and largest, shown by a perimeter line 52 of the used oil filter dome. The location of the holes 46, 47, created by the primary block spike 34 and the primary block air/solvent spike 33 during processing of the disclosed system are shown as well. The internal center tube 49 of the used oil filter, shown as dotted perimeter lines, has diameters that vary with the overall diameter of their perspective used oil filter. However, as indicated, the used oil filter primary block air/solvent spike hole 46 always enters the used oil filter at the same location no mater what the size in diameter of the used oil filter. The second region, defined in FIG. 9, highlights the location of the primary block air/solvent spike hole 46. The primary block spike hole 47 is created at the same position relative to the primary block 35 and the primary block spike 34. However, due to the diameter differences of used oil filters processed by the disclosed system this hole will vary in location relative to the physical diameter of the used oil filter being processed by the disclosed system. The first region defined in FIG. 9, highlights the possible range in location of the primary block spike hole 47.

While FIG. 9 shows the two regions in which these holes are created it is FIG. 8 that shows the actual penetration of the spikes 33, 34, of the used oil filter dome 52, FIG. 9 and the used oil filter internal dome cap 45, FIG. 8. As previously discussed, the used oil filter internal dome cap 45 is designed to prevent used oil from draining down the used oil filter center tube 49 during normal operation. As used oil flows through the used oil filter bottom steel plate oil intake holes 51, FIG. 7-A, and into the used oil filter, said cap assists in forcing the used oil to penetrate the used oil filter media 44 and remove contaminants from the used oil. Once the used oil passes through the used oil filter media 44 it exits and flows through the used oil filter center tube 49 and out the used oil filter bottom steel plate center hole 50, FIG. 7-A. By penetrating and disrupting the used oil filter dome cap 45 the disclosed system eliminates the seal created by said cap and allows for used oil and solvent to flow down the used oil filter center tube 49 and out the used oil filter bottom steel plate center hole 50, FIG. 7-A.

Although FIG. 8 illustrates the primary block spike 34 penetrating the used oil filter dome 52 the used oil filter internal dome cap 45 and entering the cavity of the used oil filter internal center tube 49. It is not necessary to enter the cavity of the used oil filter internal center tube 49 for the disclosed system to function properly. All that is required is for the primary block spike 34 to penetrate the used oil filter dome 52 and penetrate the used oil filter internal dome cap 45 within the first region, defined in FIG. 9, for the disclosed system to function properly.

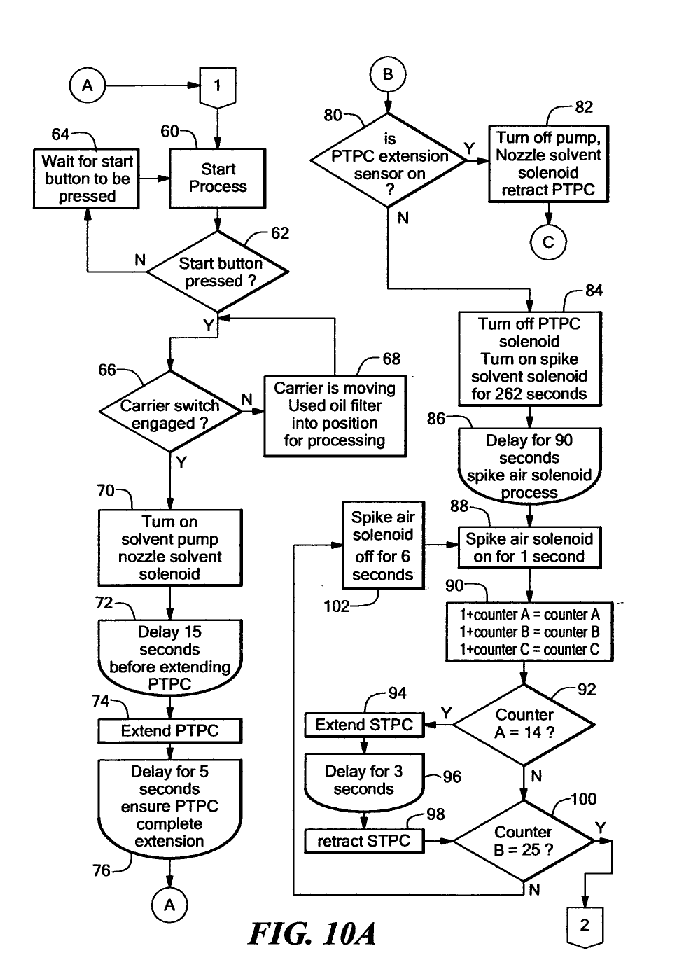

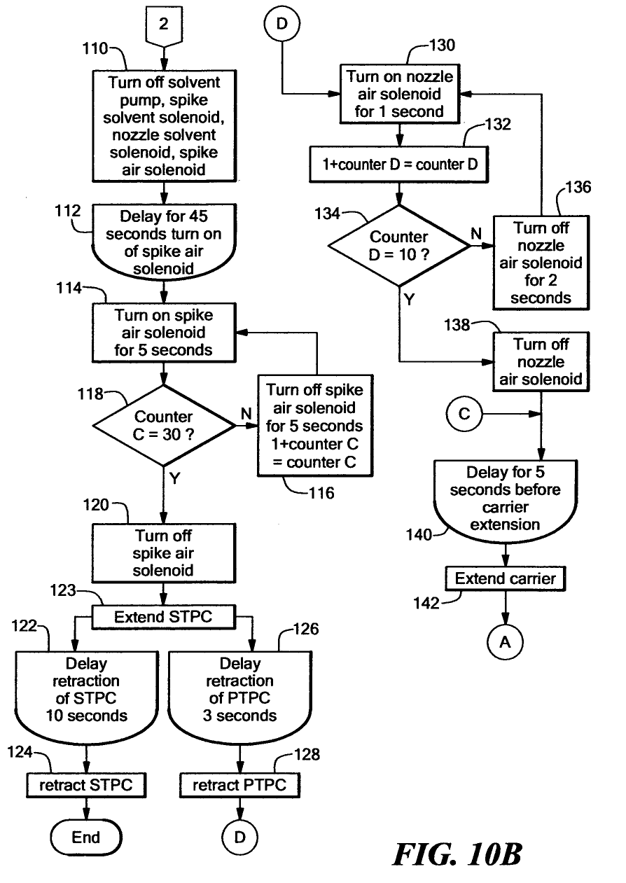

FIG. 10-A and 10-B is a flow chart of the processing cycle managed by the program logic controller. This flow chart provides systematically the preferred embodiment of this device when cleaning a used oil filter.

Operation

In the following operational description, certain specific values, such as timing or delay periods, counter limits, etc., are given with respect to the illustrative embodiment. Such specific values are provided only for purposes of explanation with regard to the illustrative embodiment, and the present invention is not limited in its application to embodiments using these specific values. Those skilled in the art will accordingly recognize that the present invention may be embodied using a variety of specific timing or delay periods, counter limits, etc., as appropriate for a given implementation or operational environment.

Operation of the automated used oil filter disclosed system employs a number of commercially available and fabricated components to provide automated functionality. These components are listed below with exemplary characteristics or minimum ratings. Some components are briefly defined and will be described in detail later in this section.
1. Program logic controller (PLC) programmed to electronically sequence events and manage components during the cleaning process.
2. External momentary on button, normally open, which signals the PLC to start the cleaning process and an emergency off button, normally open, to halt the process.
3. External air compressor with a minimum rating of 6.4 standard cubic feet per minute (SCFM) @ 90 pounds per square inch (PSI), minimum 26 gallon tank.
4. Mixture of water and oil/water separator splitting agent or solvent. This mixture, depending on solvent manufacture, can range from 30:1 (30 parts water and 1 part solvent) to 60:1. The solvent can be further characterized as generating minimal foam or suds, and operates best at temperature. This mixture allows used oil to float to the top of the mixture for removal and recycling of the solvent for further use.
5. Electronically controlled pneumatic solenoids that control pneumatic cylinders extension and retraction, compressed air, delivery to the outside of the used oil filter for drying solvent from outside of used oil filter, and compressed air delivery to the inside of the used oil filter for evacuation of waste oil and solvent. Pneumatic solenoid minimum flow ratings are as follows;
a. For the PTPC 41 a 4-way solenoid with a minimum of 56.2 SCFM and an operating PSI up to 150.
b. For the STPC 38 a 4-way solenoid with a minimum of 56.2 SCFM with an operating PSI up to 150.
c. Nozzles 3-way solenoid 60 SCFM @ 100 PSI.
d. For the primary block air/solvent spike 33 a 3-way solenoid 60 SCFM @ 100 PSI.
e. Carrier 2-way solenoid 10 SCFM @ 100 PSI.
6. Electronically controlled solenoids that control the delivery of solvent to remove waste oil from the used oil filter. Two of these solenoids are needed and are rated to handle a minimum of 5 PSI to a maximum of 150 PSI and a maximum fluid temperature of 89 2/9 Celsius.
7. Gravity assist in-line check valve to prevent solvent entering compressed air lines. Spring assist in-line check valve to prevent compressed air entering solvent lines.
8. Spray nozzles used to provide solvent to the outside of the used oil filter to remove waste oil and dirt;
a. Two full cone spray nozzles 14 inch NPT male connection, 1.5 gallons per minute @ 40 PSI with a 60 degree angle spread.
9. Spray nozzles for compressed air to the outside of the used oil filter to remove any remaining liquid from the outside of the used oil filter at the end of processing;
a. Two flat fan spray nozzles 14 inch NPT male connection, 4.96 gallons per minute @ 40 PSI.
10. Flexible plastic tubing, inside diameter of 0.635 cm or 0.9525 cm, reinforced with either plastic or wire mesh for solvent and compressed air delivery to the primary block air/solvent spike 33 and flexible plastic tubing for compressed air running between the compressed air regulators, pneumatic solenoids, pneumatic cylinders, and nozzles. Inside diameter of the compressed air tubing will vary depending on which pneumatic device that is being connected.
11. Pneumatic quick connect fittings used to connect flexible plastic tubing for compressed air to regulators, pneumatic solenoids and pneumatic cylinders. These connectors will vary in size depending on the pneumatic device. These quick connect fittings are defined as either 0.635 cm or 0.9525 cm.
12. Various sized barbed connectors, T-connectors (inside diameters equivalent to the pneumatic quick connect fittings), and tubing clamps to connect flexible plastic tubing to solvent pump, solenoids, nozzles, T-connectors, and primary block air/solvent spike 33 components to the plumbing.
13. Spark resistive pump that provides for the movement of solvent through the disclosed system. This pump is rated between 10 and 15 gallons per minute and be self priming. A non-self priming pump can be used but an in-line spring assist check valve, with a spring supplying between 3 and 5 pounds of resistive force, in front of the intake of the pump, will be required to ensure solvent is always present in the pump to properly function. Pump should be rated to handle mildly corrosive liquid up to a temperature of 82 2/9 Celsius.
14. Compressed air regulators to mange distribution of compressed air to pneumatic components. Regulators linked to components have the following PSI ratings;
a. PTPC 41 runs at 100 PSI.
b. STPC 38 runs at 60 PSI.
c. Compressed air to nozzles runs at 80 PSI.
d. Compressed air to primary block air/solvent spike 33 runs at 80 PSI.
e. Compressed air for the pneumatic device moving the carrier runs between 10 and 15 PSI.
15. Oil/water separator for removing waste oil from the solvent and recycling the solvent for cleaning additional used oil filters. Oil/water separators are commercially available and should have a holding capacity of 15 gallons or more of solvent with a minimum of two chambers. One chamber is for clean solvent, which is connected to the solvent pump for distribution of solvent for cleaning the used oil filter. The other chamber is for holding waste oil and solvent combination.
16. Oil skimmer and condenser or oil skimmer and separator. These devices are commercially available and work together to separate oil from water with less than 1% water by volume remaining in the waste oil after separation. These devices are mounted to the oil/water separator.
17. External industrial heating pads or drum heaters. These heating pads are commercially available and come in various sizes. The size of the heating pads and their number will be determined by the size of the oil/water separator. The heating pads should be able to maintain an oil/solvent temperature of 60 Celsius.

These commercially available components come in various configurations. These configurations and selection of components for a specific embodiment of the disclosed system are determined by the range of oil filter sizes, length and diameter, that will be processed. Most commercially available oil filters for automotive, light truck, and motorcycles range in diameter from 5.08 cm to 13.97 cm and 6.35 cm to 22.86 cm in height, but the disclosed system is not limited to processing such typical filter sizes. For purposes of explanation, FIG. 6-A and B shows a frame and component configuration that can process these types of oil filters.

An alternative embodiment would accommodate oil filters of smaller or larger dimensions but frame FIG. 6-A and B, primary block and primary block spikes and secondary block and spike may require changes dimensionally. Other commercially available components used in the automation process would require modifications to this design as well. However, core frame structure and functionality would stay the same and components used would be replaced with similar components that either have lower or higher capabilities to handle these other types of oil filters.

The anatomy of commercially available oil filters is also an important factor in understanding how this disclosed system functions.

The anatomy of commercially available oil filters can be generally described as a cylindrical steel container, approximately 0.15875 cm to 0.3175 cm in thickness. A domed top portion and a bottom steel plate, approximately 0.3175 cm to 0.635 cm in thickness, with a number of small holes around the circumference of the bottom steel plate 51, (waste oil under pressure flows from the engine through these holes into the oil filter) FIG. 7-A. Additionally, a single hole in the center of the bottom steel plate larger than the small holes 50, (oil flows out through this hole back into the engine after the oil has passed through the filter media) FIG. 7-A. The center hole of the bottom steel plate typically is threaded and is used to screw the oil filter on to a vehicles engine. The contents of an oil filter do vary, however, it contains either a steel or plastic center tube that will vary in diameter but will always be centered above the center hole of the bottom steel plate. This center tube runs the length of the oil filter from the center hole in the bottom plate and ends, approximately, at the point where the wall of the cylindrical steel container transitions to form the oil filter dome. Surrounding the center tube is filter media, typically paper, but can be a composite semi-porous material sufficient to block contaminants from flowing back into the engine but porous enough to allow oil to circulate through the filter media and back into the engine. This filter media runs the length of the cylindrical steel container and ends at the same point as the center tube. Below the dome and resting on the top of the filter media and over the center tube is a cap and/or spring mechanism that is designed to prevent waste oil to flow through the center tube and back into the engine. This ensures that the waste oil passes through the filter media, under pressure, and down the center tube, removing any contaminants and allowing clean oil to enter back into the engine.

The used oil filter is placed in a holder or carrier, which resides outside of the processing point of the disclosed system at the start of the cleaning process. A carrier is designed to hold the used oil filter during entry, processing and exiting points of the disclosed system. A carrier has a support plate that is sufficient in size to accommodate the largest diameter used oil filter. When the carrier is in the processing position it rests against the oil filter support plate 23. A used oil filter is orientated bottom down resting on the carrier support plate with the oil filter dome up, positioned so the primary block spikes 33, 34, can penetrate the dome and the secondary block spike 30 can penetrate the lower bottom side of a used oil filter.

A carrier can be integrated into various transport schemes that provide for movement of the used oil filter through the disclosed system. Electrical or pneumatic conveyer belts or carrousels, pneumatic slides, pneumatic cylinders are some of the possibilities. The preferred method would use a pneumatic device that could handle multiple carriers for accommodating multiple used oil filters at the entry position of the disclosed system, processing one used oil filter at a time.

The preferred embodiment of this processing frame in FIG. 6-A and B attacks the dome of the used oil filter where the primary block spikes 33, 34, penetrate, with sufficient force for delivery of compressed air and solvent to clean the inside of the used oil filter. The secondary block spike 30 situated 90 degrees below the primary track pneumatic cylinder 41 penetrates, with sufficient force, the bottom lower side of the used oil filter, used oil filter secondary block spike hole 48 to provide drainage of waste oil and solvent during the cleaning process.

An alternative embodiment for the number of spikes 33, 34, connected to the primary block 35 would be to increase the number of solid and or hollow spikes attached. However, this may result in problems with the penetration of the spikes through the dome itself due to increased surface area of the spikes as well as accommodation for the different diameters found with used oil filters.

An alternative embodiment for the number of spikes connected to the secondary block 28 would be to increase the number of solid spikes attached to the block. However, the orientation of these spikes either horizontal or vertically in relationship to bottom side of the used oil filter would require further modifications to the processing frame as well as attention to the different diameters of used oil filters. In addition, attention must be given to the spikes delivered through the dome so they do not interfere with the secondary block spikes.

An alternative embodiment for the secondary block spike 30 is to be hollow instead of solid. In addition the secondary block 28 would have a horizontal channel and hose connection for allowing solvent and compressed air to flow through the secondary spike into the used oil filter for additional cleaning.

The alternative embodiment of this processing frame in FIG. 6-A and B alters the angle position of the used oil filter by varying the angle of the primary track supports 17 with corresponding variation of secondary track supports, in a range of 0 degrees to 44 degrees or 46 degrees to 90 degrees in relation to the frame base supports 14 (this range accommodates a flat used oil filter orientation to a vertical orientation). These variations will support drainage through the hole created in the used oil filter by the secondary block spike 30 but would require changes in timing, controlled by the Program Logic Controller, of compressed air and solvent to efficiently evacuate-waste oil from the used oil filter.

An alternative embodiment for material used in the construction of the processing frame can be used and only needs to be sufficient to anchor the pneumatic cylinders as well as supporting the pressures placed on the used oil filter during processing.

An alternative embodiment for material used in the construction of the block spikes 30, 33, 34, can be any material that has similar properties to carbide in strength and durability after repeated punctures of the used oil filter.

FIGS. 10-A and B are a flow chart that represents the sequencing and timing for processing used oil filters using an illustrative embodiment of the disclosed system. In the illustrative embodiment, sequencing and timing has been maximized to process, as previously mentioned, automobile, light truck and motorcycle oil filters. At the start of the process represented by the start process block 60 in FIG. 10-A, the used oil filter is placed in the carrier. When the power on button is depressed at step 62, the carrier is brought into the processing position. The system waits for the power button to be depressed at block 62. The program logic controller starts the cleaning process once the carrier switch is determined to be engaged at block 66 (when the carrier switch is engaged this indicates that the carrier is in the processing position). Prior to the carrier switch being engaged, the carrier is moving the used oil filter into position for processing at block 68. The solvent pump and nozzle solvent solenoid are turned on at block 70, providing solvent to be distributed around the used oil filter to remove waste oil and dirt from the outside of the used oil filter. This continues for 15 seconds at block 72, and then the PTPC 41 with primary block 35 and primary block spikes 33, 34, is extended at block 74 with the primary block spikes 33, 34, entering the dome of the used oil filter.

A delay of 5 seconds occurs at block 76 before going on to the next process for the evaluation of the PTPC sensor. Although not required, many commercially available pneumatic cylinders support electronic sensors that can be triggered based on the position of the cylinder rod. When the PTPC is fully extended, the PTPC sensor turns on at block 80, indicating that the carrier is empty. This then sets in motion the shutdown of components that are on, retraction of the PTPC, the return of the carrier to the start position, and the process reset to block 60.

If the PTPC sensor is not on, the process continues with the removal of waste oil from the inside of the used oil filter. The spike solvent solenoid is turned on at block 84, allowing solvent to flow into the used oil filter. For example, this runs for 262 seconds at the same time a delay of 90 seconds is implemented at block 86 before the spike air solenoid is turned on at block 88. During this time the solvent displaces most of the waste oil, which with the solvent travels past the disrupted used oil filter internal dome cap 45, and down the center tube 49 of the used oil filter, which then drains into the oil/water separator. Once the 90 seconds is up and while the spike solvent solenoid is still on, the spike air solenoid is turned on for 1 second at block 88, and then turned off for 6 seconds. This process agitates the solvent and removes the remaining waste oil from the filter. Counters are used to initiate various sub functions during this process, and incremented in block 90. When counter (A) reaches 14 at block 92 or after 98 seconds of 1 second on, at block 88 and 6 seconds off the spike air solenoid at block 102, the STPC is extended at block 94 and retracted at block 98 following a 3 second delay at block 96. The STPC places a hole on the bottom lower side of the used oil filter 0.635 cm up from the bottom of the used oil filter to allow drainage of waste oil and solvent, shown as used oil filter secondary spike hole 48, FIG. 7A. The spike air solenoid, 1 second on and 6 seconds off cycle, continues until counter (B) reaches 25 (or another 71 seconds) at block 100, compressed air flows through primary block air/solvent channel 32 and then through the primary block air/solvent spike 33 into the used oil filter as illustrated in FIG. 8. Once counter (B) reaches 25 at block 100, the solvent pump, spike solvent solenoid, nozzle solvent solenoid, and spike air solenoid are turned off at block 110. A delay of 45 seconds at block 112 takes place to allow settling of liquid still remaining in the used oil filter, draining continues during this delay. After the 45 second delay the spike air solenoid is turned on for 5 seconds at block 114 then turned off for 5 seconds at block 116 until counter (C) reaches 30 at block 118. This final process evacuates the remaining liquid in the used oil filter through the used oil filter center tube 49 and used oil filter secondary spike hole 48. When counter (C) reaches 30 at block 118 the spike air solenoid is turned off at block 120.

The process continues on to extending the STPC at block 123 and delaying retraction of the STPC for 10 seconds at block 122. This process anchors the used oil filter in place so that the PTPC can be retracted. A delay for the first 3 seconds for the STPC delay occurs at block 126 to ensure STPC penetration then the PTPC is retracted at block 128 and after the 10 second delay at block 122 finishes the STPC is retracted at block 124. The nozzle air solenoid is then turned on for 1 second at block 130, and then off for 2 seconds at block 136 to dry and remove any remaining liquid on the outside of the used oil filter. This continues for 30 seconds or when counter (D), which is incremented at block 132, reaches 10 at block 134. Once counter (D) reaches 10 at block 134, the nozzle air solenoid is turned off at block 138 and a delay of 5 seconds occurs at block 140 before the return at block 142 of the carrier to the start position and then the removal of the cleaned used oil filter from the carrier.

The above description of the preferred embodiments includes a flowchart diagram illustration (FIGS. 10A-10B) of methods, apparatus (systems) and computer program products according to an embodiment of the invention. Those skilled in the art will recognize that the specific orders of steps shown in the flow chart are given purely for purposes of illustration, and that the specific order in which the described operations are performed may vary between embodiments, configurations, or based on specific operational conditions. It will be further understood that each block of the flowchart diagram illustration, and combinations of blocks, can be implemented at least in part through the execution of computer program instructions. The computer program instructions may be loaded onto a computer or other programmable data processing apparatus to cause a series of operational steps to be performed on the computer or other programmable apparatus to produce a computer driven process such that the instructions which execute on the computer or other programmable apparatus provide, at least in part, steps for implementing the functions specified in the block or blocks.

Finally, while the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

1. A method of cleaning a used oil filter, comprising:
penetrating a first region of a top surface of said used oil filter with a first spike, wherein said first region of said top surface of said used oil filter is located over a center tube of said used oil filter; and
penetrating a second region of said top surface of said used oil filter with a second spike, wherein said second region of said top surface of said used oil filter is outside of said first region of said top surface of said used oil filter.

2. The method of claim 1, further comprising passing compressed air into a hole in said top surface of said used oil filter caused by said penetrating of said top surface of said used oil filter.

3. The method of claim 1, further comprising passing a liquid into a hole in said top surface of said used oil filter caused by said penetrating of said top surface of said used oil filter.

4. The method of claim 1, wherein said penetrating said first region of said top surface of said used oil filter is performed by a solid spike.

5. The method of claim 1, wherein said penetrating said second region of said top surface of said used oil filter is performed by a hollow spike, and wherein compressed air and a liquid are passed into said used oil filter through said hollow spike.

6. The method of claim 1, wherein said penetrating of said first region of said top surface of said used oil filter further comprises disrupting an internal structure of said used oil filter.

7. The method of claim 1, further comprising penetrating a sidewall of said used oil filter, wherein said penetrating said sidewall of said used oil filter provides for draining of liquid from said used oil filter.

8. The method of claim 1, wherein said second region of said top surface of said used oil filter is located over a space between filter material in said used oil filter and a sidewall of said used oil filter.

9. A system for cleaning a used oil filter, comprising:
a first spike for penetrating a first region of a top surface of said used oil filter with a first spike, wherein said first region of said top surface of said used oil filter is located over a center tube of said used oil filter; and
a second spike for penetrating a second region of said top surface of said used oil filter with a second spike, wherein said second region of said top surface of said used oil filter is outside of said first region of said top surface of said used oil filter.

10. The system of claim 9, further comprising a path for passing compressed air into a hole in said top surface of said used oil filter caused by said penetrating of said top surface of said used oil filter by said second spike.

11. The system of claim 9, further comprising a path for passing a liquid into a hole in said top surface of said used oil filter caused by said penetrating of said top surface of said used oil filter by said second spike.

12. The system of claim 9, wherein said first spike for penetrating said first region of said top surface of said used oil filter comprises a solid spike.

13. The system of claim 9, wherein said second spike for penetrating said second region of said top surface of said used oil filter comprises a hollow spike, and wherein compressed air and a liquid are passed into said used oil filter through said hollow spike.

14. The system of claim 9, wherein said first spike for penetrating of said first region of said top surface of said used oil filter further operates to disrupt an internal structure of said used oil filter.

15. The system of claim 9, further comprising a third spike for penetrating a sidewall of said used oil filter, wherein said third spike for penetrating said sidewall of said used oil filter provides a hole in said used oil filter for draining of liquid from said used oil filter.

16. The system of claim 9, wherein said second region of said top surface of said used oil filter is located over a space between filter material in said used oil filter and a sidewall of said used oil filter.

17. A system for cleaning a used oil filter, comprising:
means for penetrating a first region of a top surface of said used oil filter with a first spike, wherein said first region of said top surface of said used oil filter is located over a center tube of said used oil filter; and
means for penetrating a second region of said top surface of said used oil filter with a second spike, wherein said second region of said top surface of said used oil filter is outside of said first region of said top surface of said used oil filter.

18. The system of claim 17, further comprising means for passing compressed air into a hole in said top surface of said used oil filter caused by said penetrating of said top surface of said used oil filter.

19. The system of claim 17, further comprising means for passing a liquid into a hole in said top surface of said used oil filter caused by said penetrating of said top surface of said used oil filter.

20. The system of claim 17, wherein said means for penetrating said first region of said top surface of said used oil filter includes a solid spike.

21. The system of claim 17, wherein said means for penetrating said second region of said top surface of said used oil filter includes a hollow spike, and wherein compressed air and a liquid are passed into said used oil filter through said hollow spike.

22. The system of claim 17, wherein said means for penetrating of said first region of said top surface of said used oil filter further operates to disrupt an internal structure of said used oil filter.

23. The system of claim 17, further comprising means for penetrating a sidewall of said used oil filter, wherein said means for penetrating said sidewall of said used oil filter provides for draining of liquid from said used oil filter.

24. The system of claim 17, wherein said second region of said top surface of said used oil filter is located over a space between filter material in said used oil filter and a sidewall of said used oil filter.
